(19) United States
(12) Patent Application Publication
(10) Pub. No.: US 2016/0084755 A1
(43) Pub. Date: Mar. 24, 2016

(54) EVAPORATIVE VEHICLE EMISSION LOSS DETECTION FROM A NON-OPERATING VEHICLE

(71) Applicant: Nexus Environmental, LLC, Miami Beach, FL (US)

(72) Inventor: Pradeep R. Tripathi, Miami Beach, FL (US)

(21) Appl. No.: 14/849,699

(22) Filed: Sep. 10, 2015

Related U.S. Application Data
(60) Provisional application No. 62/053,324, filed on Sep. 22, 2014.

(51) Int. Cl. G01N 21/3504; G01M 3/38; G01M 15/04

(52) U.S. Cl. CPC G01N 21/3504; G01M 15/042; G01M 3/38

(57) ABSTRACT

An evaporative gas analysis system and method for detecting and measuring levels of hydrocarbons emitted from gasoline motor vehicles while stationary with the engine off includes a monochromatic source for producing and transmitting a beam of visible radiation through a portion of hydrocarbon gas surrounding the motor vehicle thereby causing the gas surrounding the vehicle to emit chromatic radiation based on the gas present. A receiver is positioned to receive the emitted chromatic radiation. The receiver including a plurality of chromatic sensors, each generating an electrical signal indicative of transmission of hydrocarbon gas surrounding the vehicle. A control is responsive to the chromatic sensors for computing the relative concentration of hydrocarbon gas surrounding the vehicle from the electrical signals.

### CROSS REFERENCE TO RELATED APPLICATION

This application claims priority from U.S. patent application Ser. No. 62/053,324, filed on Sep. 22, 2014, the disclosure of which is hereby incorporated herein by reference.

### BACKGROUND OF THE INVENTION

Motor vehicle emissions arise from two major sources: exhaust emissions and evaporative losses from the vehicle fuel system (tank, injection system, fuel lines, etc.). Proper functioning of a vehicle's evaporative emission system prevents fuel vapors from escaping into the atmosphere. Evaporative emissions can be a much greater source of hydrocarbon (HC) pollution than exhaust emissions, especially in hot weather. Most traditional I/M tests (Idle test, ASM2525, ASM5015, etc.) do not measure evaporative emission directly and, at the most, only do a simple gas cap check.

Evaporative emissions occur as a result of fuel volatility combined with either the diurnal (daily) variation of the ambient temperature or the temperature changes of the vehicle fuel system, which occur during normal driving procedure. Automotive evaporative emissions mainly consist of light hydrocarbon vapor consisting essentially of C4 to C6 hydrocarbons.

There are several different mechanisms by which gasoline evaporates from vehicles and, therefore, different types of evaporative emissions:
Diurnal emissions. These occur while a vehicle is stationary with the engine off and are due to the thermal expansion and emission of vapor mainly from the fuel tank as a result of the diurnal changes of ambient temperature. This mechanism is also known as “tank breathing.”
Running losses. These are defined as emissions which occur while the vehicle is being driven. The heat emitted from the engine and the changing windblast result in variable temperatures in the fuel system.
Hot soak losses. These occur when a warmed-up vehicle is stationary and the engine is stopped. In the absence of windblast, more engine heat is dissipated into the fuel system. The increasing temperature causes evaporative emissions.
Crankcase emissions. Although not a “true” evaporative source, these are generally considered to be in the evaporative emissions category. They are substances emitted directly to the atmosphere from any opening leading to the crankcase of a motor vehicle engine. Crankcase emissions from later model vehicles are largely controlled by Positive Crankcase Ventilation (PCV) systems, and therefore, are the result of tampered or defective PCV systems. Overall, crankcase emissions are very small.
Resting Losses. These are only found in some newer references as a separate evaporative source, resulting from diffusion, permeation, seepage and minor liquid leaks. If the resting losses are not considered a separate category, they are included in the hot soak and diurnal categories. They can also be understood as background emissions, independent of diurnal tank breathing. Resting losses do not need an increase of the fuel temperature to occur.
Refueling losses. These occur while the tank is being filled and the saturated vapors are displaced and vented into the atmosphere. They are usually attributed to the fuel-handling chain and not to the vehicle emissions. Vapor recovery systems are implemented to control refueling losses.
Fuel Cap losses. These occur when the fuel cap is either defective or missing.

Currently there are only four types of EVAP test: Evaporative System Pressure Test, the Evaporative Purge Test, the FTP Diurnal Test and simple Gas Cap Pressure Test.

### Evaporative System Pressure Test

The pressure test checks the system for leaks that would allow fuel vapors to escape into the atmosphere. A “pressure decay” method is used to monitor for pressure losses in the system. In this method, the vapor lines to the fuel tank and the fuel tank itself are filled with nitrogen to a pressure of 14 inches of water (about 0.5 psi). To pressurize these components, the inspector must locate the evaporative canister, remove the vapor line from the fuel tank, and hook up the pressure test equipment to the vapor line. After the system is filled, the pressure supply system is closed off and the loss in pressure is observed. If pressure in the system remains above eight inches of water after two minutes, the vehicle passes the test.

A source of nitrogen, a pressure gauge, a valve, and associated hoses and fittings are needed to perform the pressure test. In addition, a computer is used to automatically meter the nitrogen, monitor the pressure, and collect and process the results. Algorithms will be developed to optimize the test so that a pass/fail decision can be made in less than two minutes on most vehicles.

### Evaporative Purge Test

The evaporative purge test is performed during the IM240 transient (drive cycle) test, referenced in the figure below. A flow transducer is placed in series with the purge line between the canister and engine. In order to pass, the system must purge at least 1 liter of flow by the end of the IM240 drive cycle. FIG. 12 illustrates a graph of the IM240, 240 second drive cycle.

### FTP Diurnal Test

The diurnal emission test for gasoline-, methanol- and gaseous-fueled vehicles consists of three 24-hour test cycles following the hot soak test. Evaporative emissions are measured for each 24-hour cycle, with the highest emission level used to determine compliance with the standards. The test consists of sealing the vehicle within an enclosure in order to measure its evaporative (i.e., hydrocarbon concentration) emission. The emission sampling period shall occur 1440±6, 2880±6, 4320±6 minutes, respectively. At the end of each emission sampling period, analyze the enclosure atmosphere for hydrocarbons and record.

### Gas Cap Pressure Test

The gas cap pressure test is performed by removing the cap from the vehicle and then attaching to a device that tests the cap integrity under normal gasoline tank pressure.

Based on the tests described above, it is obvious that three of the tests are quite involved with the FTP test procedure being onerous for the general public. And the results of the gas cap test, though easy to implement, are very limited in scope for identifying overall evaporative emission failure.

Note that all of these tests involve most vehicles in a non-attainment area to submit to typically an annual or biennial vehicle emission test.

### SUMMARY OF THE INVENTION

The present invention provides a device and a method that can unobtrusively identify a vehicle as potentially having evaporative emission based on a simple scan of the vehicle's immediate surrounding environment.

An evaporative gas analysis system and method for detecting and measuring levels of hydrocarbons emitted from gasoline motor vehicles while stationary with the engine off, according to an aspect of the invention, includes a monochromatic source for producing and transmitting a beam of visible radiation through a portion of hydrocarbon gas surrounding the motor vehicle thereby causing the gas surrounding the vehicle to emit chromatic radiation based on the gas present. A receiver is position to receive the emitted chromatic radiation. The receiver including a plurality of chromatic sensors, each generating an electrical signal indicative of transmission of hydrocarbon gas surrounding the vehicle. A control is responsive to the chromatic sensors for computing the relative concentration of hydrocarbon gas surrounding the vehicle from the electrical signals.

The source may be a visible laser beam. The emitted chromatic radiation may be generated by Raman spectral effect. The monochromatic source may use light dispersion to generate different wavebands of light. The plurality of sensors may be a spectrometer. A telescope head may be provided to focus the emitted chromatic radiation.

An evaporative gas analysis system and method for detecting and measuring levels of hydrocarbon gas emitted from gasoline motor vehicles while stationary with the engine off, according to an aspect of the invention, includes a source that produces and transmits a beam of infrared radiation through a portion of gas surrounding the vehicle, wherein the vehicle and a background of the vehicle reflects the infrared radiation through a portion of the gas surrounding said vehicle. A receiver is positioned to receive the reflected infrared radiation. An infrared sensor is responsive to the receiver and generates an absorption electrical signal indicative of absorption of the hydrocarbon gas surrounding the vehicle and also generates a reference electrical signal indicative of the total radiation of the infrared beam by gas surrounding the vehicle. A control is responsive to the absorption and reference electrical signals from the infrared sensor for computing the relative concentration of the hydrocarbon gas through the portion of the gas surrounding the vehicle.

The infrared sensor may generate a reference signal using time domain multiplexing. A spinning filter wheel with one or more filters may identify the absorption of hydrocarbon gas and one or more filters may identify the reference radiation that is unaffected by the absorption of hydrocarbon gas to perform the time domain multiplexing. The infrared sensor may be a single infrared sensor. A telescope head may be provided to focus the reflected infrared radiation.

An evaporative gas analysis system and method for detecting and measuring levels of hydrocarbons emitted from gasoline motor vehicles while stationary with the engine off, according to an aspect of the invention, includes a source of infrared radiation which passes through a portion of gas surrounding the vehicle and a receiver. The receiver is positioned to receive the infrared radiation which passes through a portion of the gas surrounding the vehicle. An infrared sensor is responsive to the receiver to generate an electrical signal indicative of the absorption of the hydrocarbon gas surrounding the vehicle and generates a reference electrical signal indicative of the total radiation of the source of infrared radiation. A control is responsive to the electrical signals from the infrared sensor for computing the relative concentration of the hydrocarbon gas surrounding the vehicle that is emitted by the vehicle.

The source may be the inherent infrared radiation of the vehicle and its background. The infrared sensor may include a time division multiplexor to generate the electrical signal indicative of the absorption of the hydrocarbon gas and the reference electrical signal. The time division multiplexor may include a spinning filter wheel with one or more filters that identify the absorption of hydrocarbon gas and one or more filters that identify the reference radiation that is unaffected by the absorption of hydrocarbon gas. A telescope head may be provided to focus the received infrared radiation.

An evaporative gas analysis system and method for detecting and measuring levels of hydrocarbons emitted from gasoline motor vehicles while stationary with the engine off, according to an aspect of the invention, includes a source of infrared radiation which passes through a portion of the gas surrounding said vehicle and a receiver. The receiver is positioned to receiving the infrared radiation reflected from gas surrounding the vehicle. A plurality of infrared sensors generate electrical signals indicative of the absorption of the hydrocarbon gas surrounding the vehicle and also generate a reference electrical signal indicative of the total radiation of said infrared beam by the gas surrounding the vehicle. A control is responsive to the electrical signals from the infrared sensors for computing the relative concentrations of hydrocarbon through the portion of the gas surrounding the vehicle.

The source may be the inherent infrared radiation of the vehicle and its background. The plurality of sensors may be an MID IR camera. The plurality of sensors may be provided by a time division multiplexor. The time division multiplexor may include a spinning filter wheel with at least one filter that identifies the absorption of hydrocarbon gas and at least one other filter that identifies the reference radiation that is unaffected by the absorption of hydrocarbon gas. A telescope head may be provided to focus the reflected infrared radiation. The control may use a synthetic reference to calculate absolute absorption of evaporative emission. The receiver may be a MID IR camera to identify the possible location of the evaporative leak.

The control may determine whether the measured hydrocarbon emissions exceed an acceptable limit and warrant repair of the vehicle. The control may locate potential areas of the vehicle that are possible sources of hydrocarbon emission. The system may be directed under the hood of the vehicle to locate the possible sources of the hydrocarbon leak(s).

The present invention, as defined in the claims below, satisfies the need of a remote-sensing technique for fast and affective identification of a vehicle's evaporative emission for part of a standard emission test and for off cycle tests of non-operating vehicles in situ, i.e., vehicles parked with the engine shut off. The invention is embodied in a series of devices and methods that will remotely measure the evaporative emission of a non-operating vehicle in situ, i.e., parked with the engine turned off.

These and other objects, advantages and features of this invention will become apparent upon review of the following specification in conjunction with the drawings.

### BRIEF DESCRIPTION OF THE DRAWINGS

FIG. 1 is a block diagram of an evaporative vehicle emission loss detection system according to an embodiment of the invention;

FIG. 2 is the same view as FIG. 1 of an alternative embodiment thereof;

FIG. 3 is a diagram of a pattern traced by the scanning laser beam in the system in FIG. 2;

FIG. 4 is the same view as FIG. 1 of an alternative embodiment thereof;

FIG. 5 is a plot of light transmission measured by a spectrometer in relation to a reference for gasoline at various wavelengths;

FIG. 6 is the same view as FIG. 5 showing generation of a synthetic reference;

FIG. 7 is the same view as FIG. 1 of an alternative embodiment thereof;

FIG. 8 is an enlarged view of a filter wheel;

FIG. 9 is the same view as FIG. 1 of an alternative embodiment thereof;

FIG. 10 is the same view as FIG. 1 of an alternative embodiment thereof;

FIG. 11 is a false colored image generated by the system in FIG. 10;

FIG. 12 illustrates a graph of the IM240, 240 second drive cycle;

FIG. 13 depicts the spectrum in the near infrared (NIR) through mid-infrared (MIR) of three types of distillate fuel vapors: unleaded gasoline, Diesel Fuel (DF2) and Jet Fuel (JP-8); and

FIG. 14 illustrates a real time display that which would indicate the level of evaporative emission using a dial with a color background indicating the level of emission.

### DETAILED DESCRIPTION OF THE PREFERRED EMBODIMENT

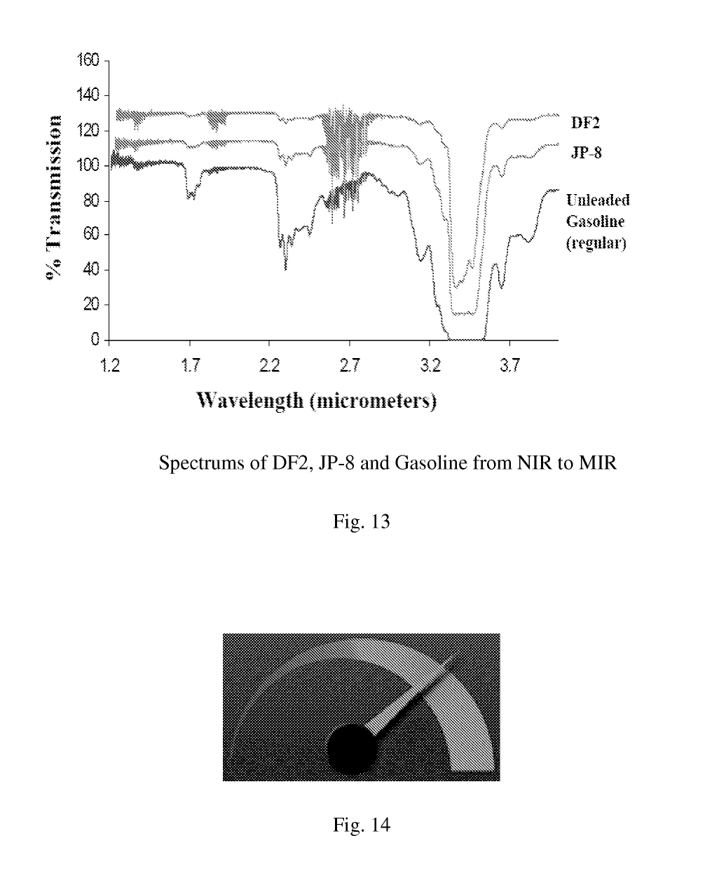

Referring now to the drawings and the illustrative embodiments depicted therein, the diagram illustrated in FIG. 13 depicts the spectrum in the near infrared (NIR) through mid-infrared (MIR) of three types of distillate fuel vapors: unleaded gasoline, Diesel Fuel (DF2) and Jet Fuel (JP-8).

The embodiments below are intended to concentrate on the unleaded gasoline curve shown in FIG. 13, but could find application for other fuels as well. While there are multiple distinct absorption regions that are centered on 1.7, 2.4 and 3.4 micron wavelengths, the disclosed embodiments are for use in sensing evaporative emissions around the 1.7 and 3.4 micron sections of the curve. The main reasons for looking at this region of the spectrum is that there exists COTS mini spectrometers that are commercially available from sources, such as Ocean Optics and others, that measure in the NIR from 1.000 to 2.500 microns. Also, the use of a synthetic referencing for determining a baseline reference points facilitates measurement in these regions, as will be described in more detail below.

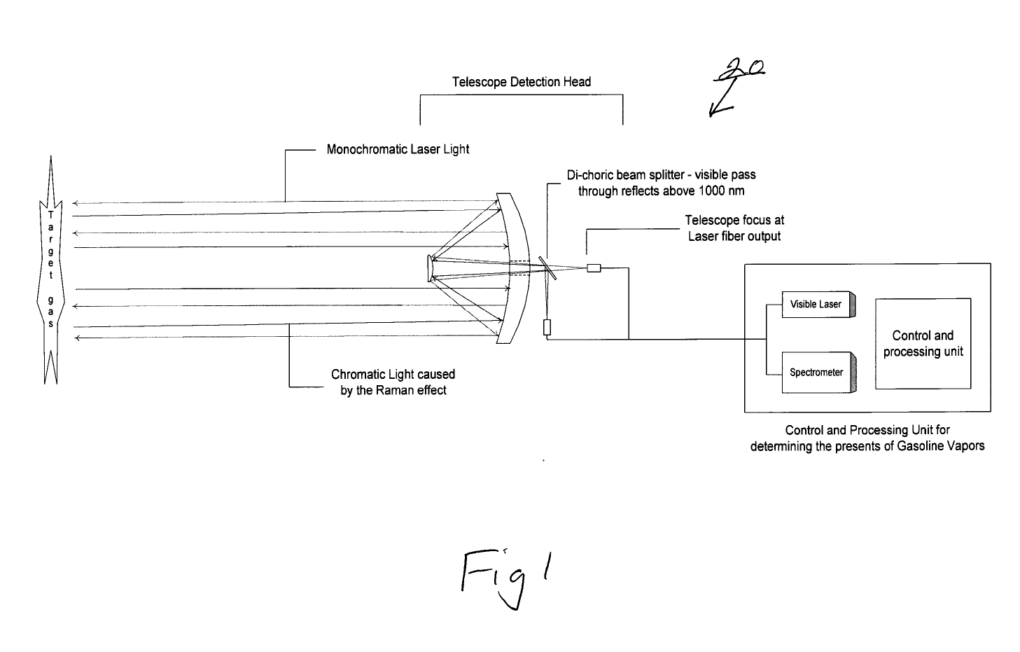

An evaporative vehicle emission loss detection system 10 measures gasoline vapor using Raman spectroscopy (FIG. 1). Raman spectroscopy is well known in the art. A light source 12 that is a monochromatic source, such as a laser, is used as an excitation source to stimulate the Raman effect in a gas sample 14 surrounding the vehicle. The laser light is absorbed by the gas molecules in gas sample 14 and then light of different quencies is emitted based on the vibrational, rotational and other low frequency electron transitions in the gas molecules. A telescope head 16, which is embodied in a Schmidt Cassegrain telescope, distributes the collimated laser light to the sample. Laser source 12 is the end of a fiber optic cable 18 that is placed at the focal length of the telescope. Based on the Raman effect, the sample 14 emits chromatic light which is then gathered by telescope 26 and then split by a beam splitter 30 and focused into the fiber optic cable 28 attached to an NIR spectrometer 32. The spectrometer's response is designed to maximize its sensitivity around the 1.7 microns based on the absorption of gasoline vapor and surrounding wave bands. A control system 34 controls and reads the output of spectrometer 32 and converts the data from raw voltage readings into information necessary to identify the presence of gasoline vapor surrounding the vehicle which is parked with the engine not running.

In the illustrated embodiment, beam splitter 30 is a dichroic beam splitter which allows light waves in the visible spectrum to pass through the splitter while light waves in the NIR are reflected by the splitter. Because the splitter is at an angle (most likely 45°) the exact position of the focal point will be slightly shifted due to refraction.

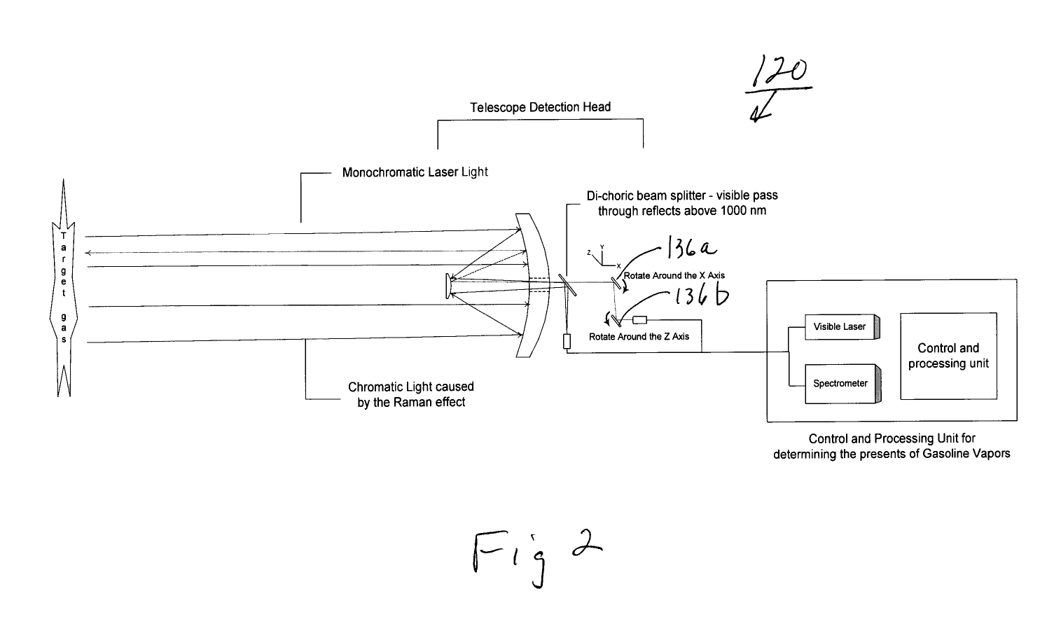

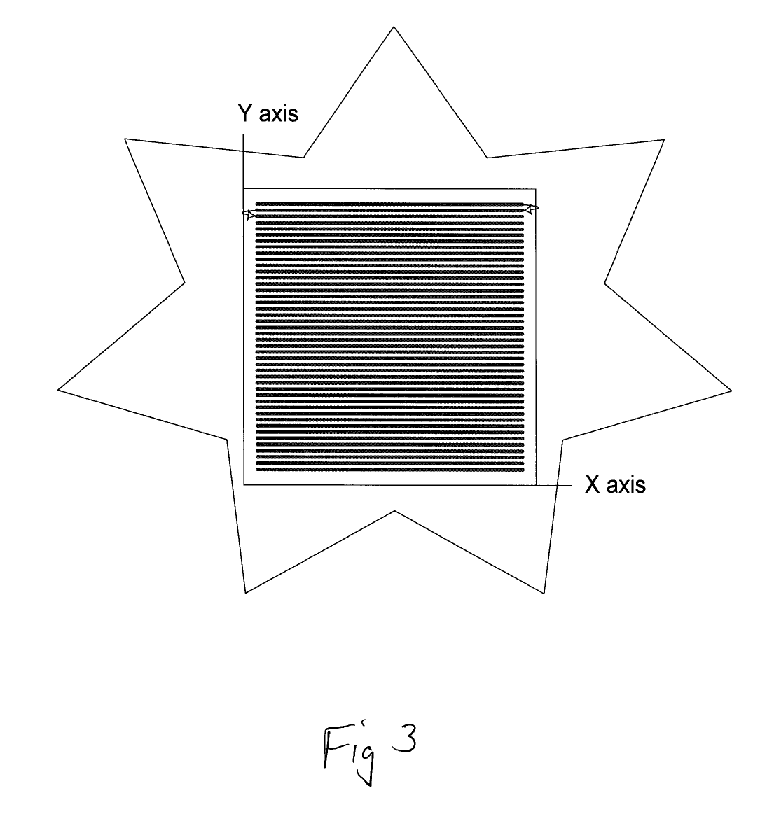

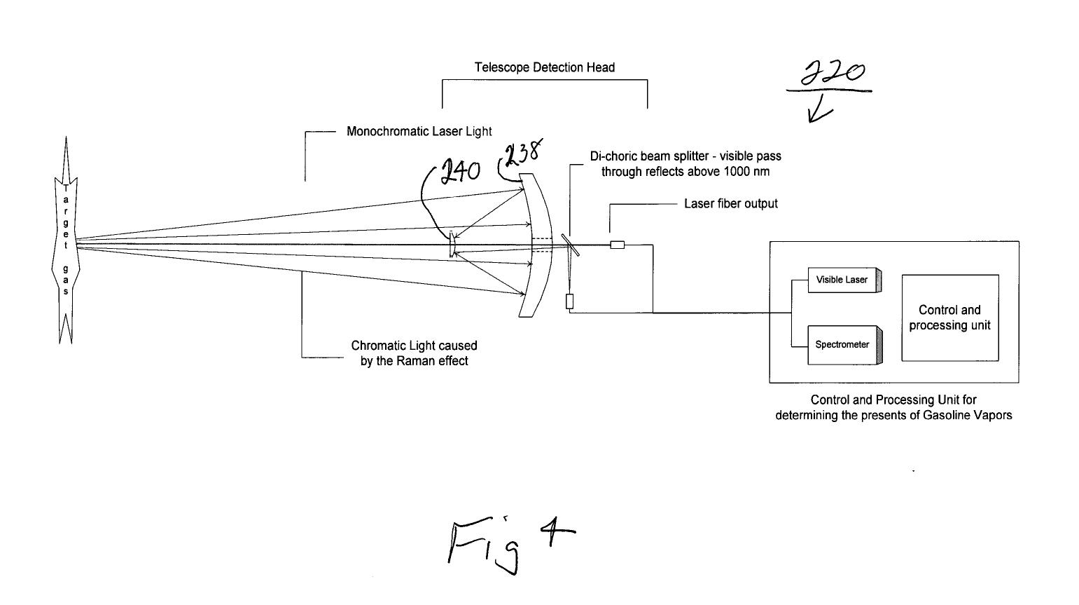

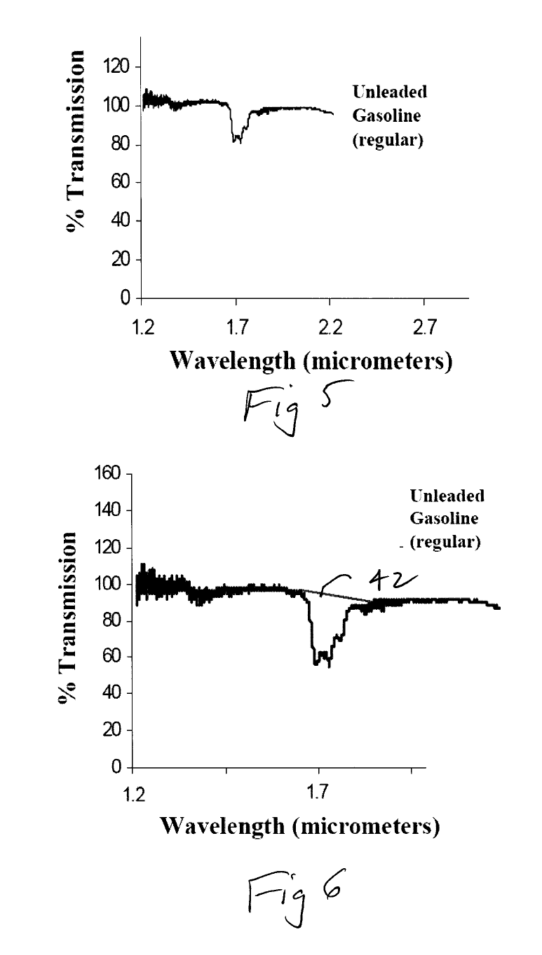

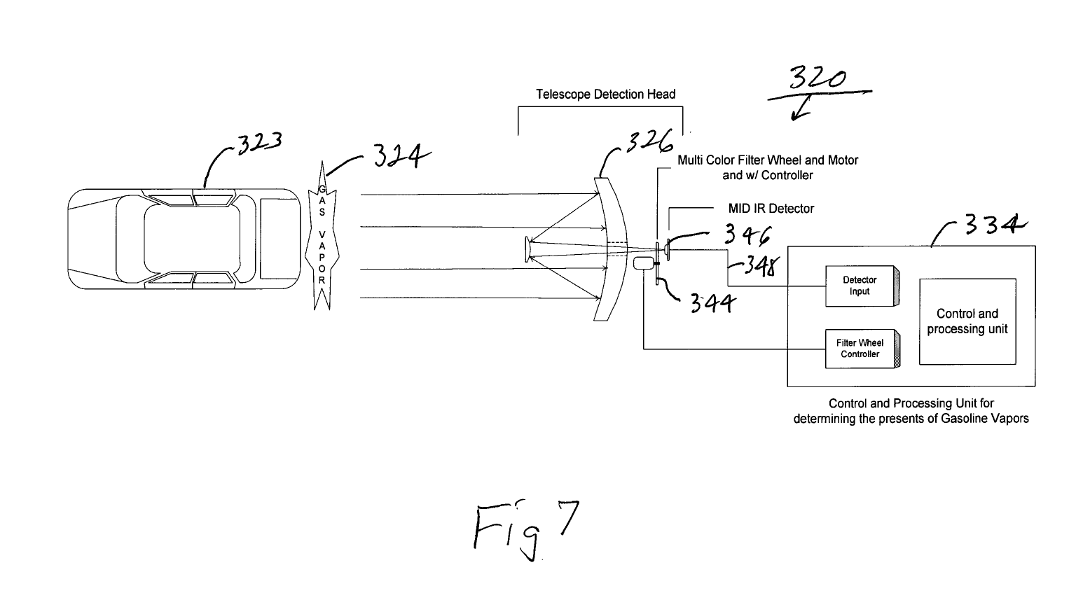

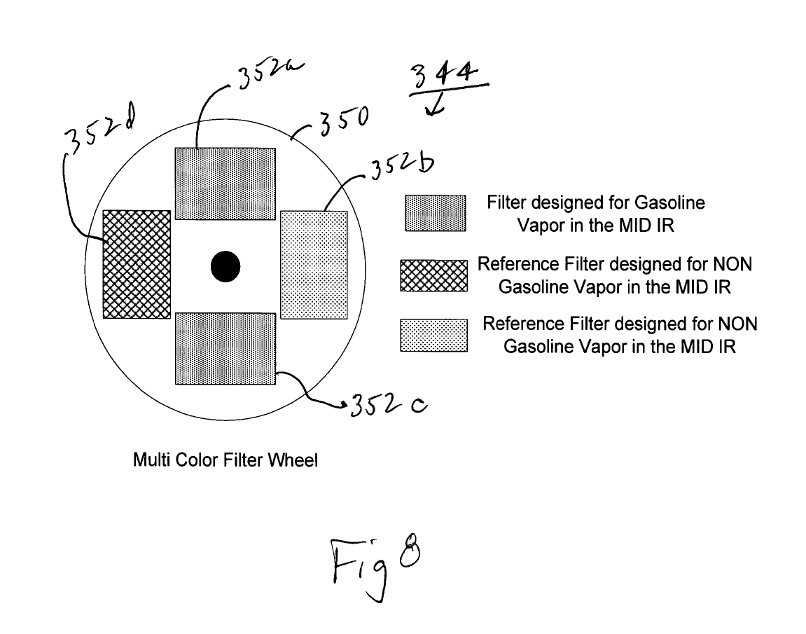

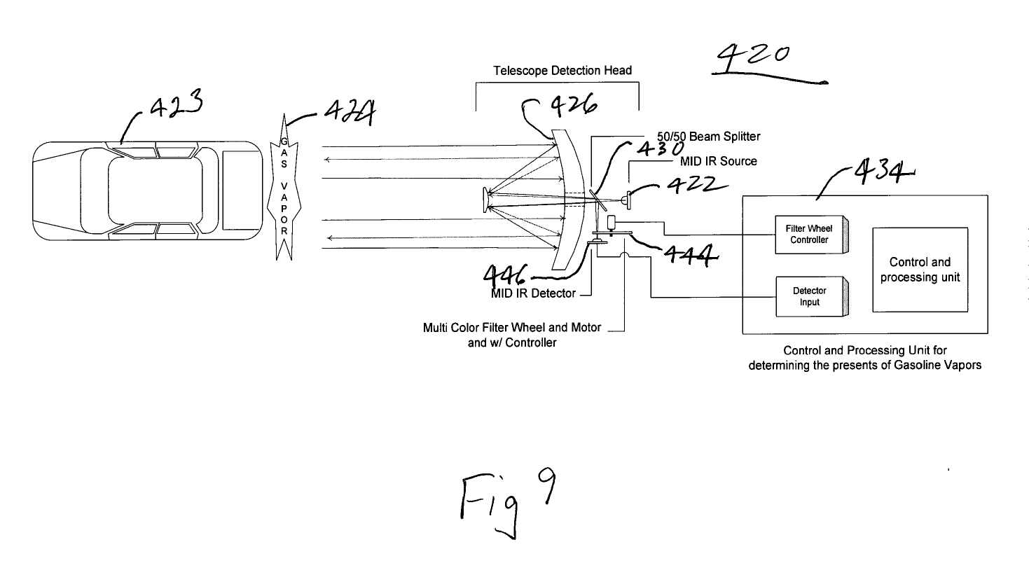

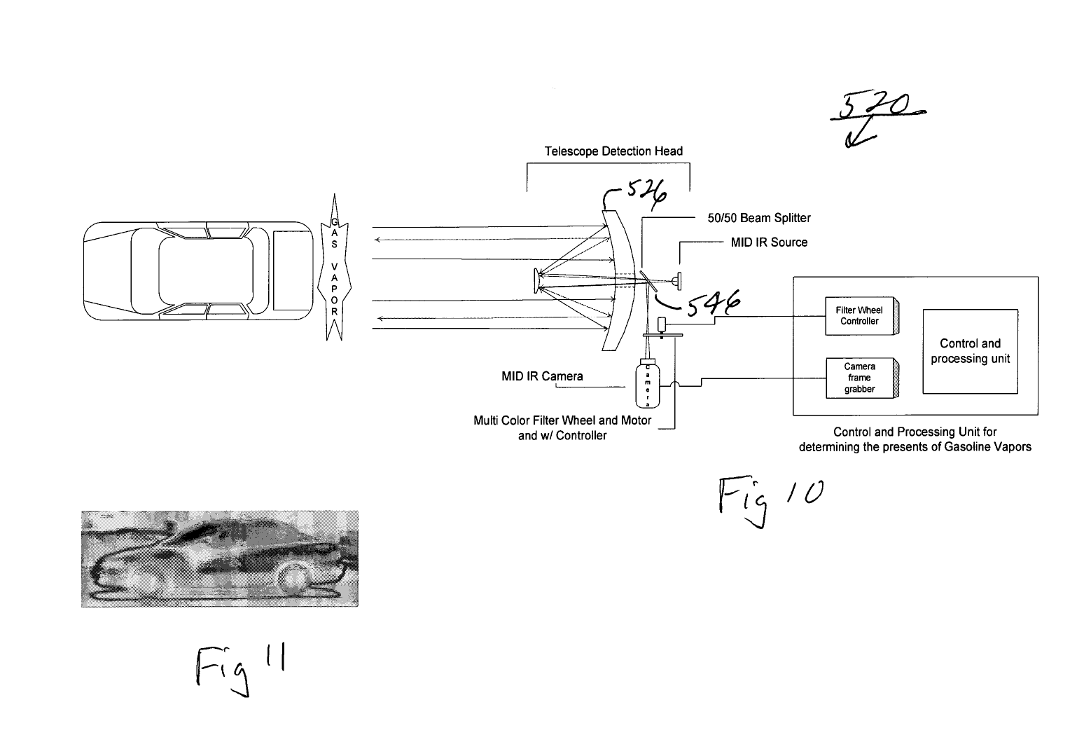

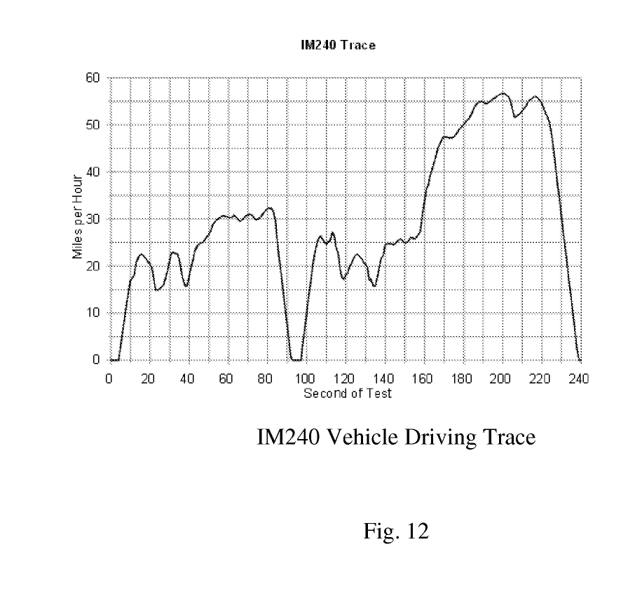

An evaporative vehicle emission loss detection system 120 measures the presence of gasoline vapor at a vehicle that is parked with the engine not running (FIG. 2). A light source 122, such as a laser source, is collimated to a narrow laser beam source that is rapidly scanned over the gas sample 124. This is accomplished by using two first surface minors 136a and 136b that rotate around the Z axis (perpendicular to the page) and X axis, respectively. The rotation movement will be over shallow angles based on the optics of a telescope 126 and the desired Field of View (FOV) of sample 124. An example of a potential scan pattern is illustrated as the horizontal lines in FIG. 3. The laser beam starts along the X axis inscribing a laser line on the gas sample by mirror 136a. At the end of the line, the movement of minor 136b about the Z axis moves the beam in the Y axis and the laser scans again along the X axis but in the opposite direction. This is repeated until the full FOV is scanned and then the process is reversed to scan the FOV in the other direction. The detection and control portions of the system, other than the control of the scanning minors, are identical to that of the non-scanning system 20 in FIG. 1.

An alternative evaporative vehicle emission loss detection system 220 uses Raman spectroscopy (FIG. 4). System 220 uses a light source 222 that is a single direct non-scanning laser beam. Telescope head 126 has a primary minor 138 and a secondary minor 140, both having an aligned small hole along the optical axis of telescope head 226. This allows the laser beam to travel directly out the front of the device toward the gas sample 224. The laser light causes the Raman effect and sample 224 emits chromatic light. The chromatic light is received by the primary minor 238, focused on to the secondary mirror 240 which is focused via a dichroic beam splitter 230 into the fiber optic cable 228 connected to a spectrometer 232. The detection and control portions of system 220 are identical to that of the systems 20 and 120 discussed previously. The primary and secondary mirrors will need to be configured based on the distance between the telescope 226 and the gas sample 224. When samples are close to the telescope, chromatic light emitted from the sample is not always on the optical axis of the telescope and, hence, may not focus correctly into the spectrometer optical fiber.

Spectrometers use light dispersion. Chromatic light is dispersed and broken into very small monochromatic regions much like a prism takes visible light and spreads it into a rainbow of colors. This dispersed light is focused onto a linear array of equally very small spaced detector pixels. Each pixel detects a very small wavelength region of light usually in the 0.01 to 0.001 micron range. Systems 20, 120 and 220 use spectrometers for detecting the presence of gasoline vapor. The measurements are also all relative transmission measurements that are relevant to a reference value. That is to say that the % transmission that is represented at the various points in the graph in FIG. 5 are all relative to the intensity of the source, noise, gas interference, etc. Reference point(s) for measures made around the 1.7 micron region for determining the exact amount of absorption (if any) by gasoline vapor create a difficulty. A solution is to use a synthetic referencing illustrated in FIG. 6. Synthetic referencing uses a mathematical generated reference spectrum. In the illustrated embodiment, it is an equation that follows the intensity data on both sides of the gasoline vapor absorption peak using an equation that is applied to interpolation the reference points in the gasoline vapor absorption region. A comparison of FIG. 5 without a synthetic reference and FIG. 6 with a synthetic reference 42 illustrates a graphical representation of this feature. When calculating the absorption of a single pixel around the 1.7 micron region, the reference value in the absorption equation is calculated using the synthetic reference equation. One of the advantages of this method is that the reference value is calculated co-incident with the actual gasoline vapor measurement and, hence, compensates for the source variations, noise, gas interference, and the like.

An evaporative vehicle emission loss detection system 330 uses a non-dispersive infrared (NDIR) technique with discrete detectors with bandpass filters (FIG. 7). Chromatic light is directed onto a bandpass filter 344 with a detector 346 that measures a very specific wavelength region or band in which the gas of interest absorbs. These wavelength bands are usually broad and cover a 0.10's to 0.01's of microns in wavelength. Detector 346 gives a single output 348 based on the gas's absorption.

FIG. 8 illustrates a bandpass filter 344 having a rotating support 350 and a plurality of filter media 352a, 352b, 352c and 352b. All objects emit IR based on the temperature of the object. The hotter the temperature the more the object emits radiation. Planck's equation can be used to determine the amount of radiation an object emits based on its temperature and emissivity for specific wavebands of interest. System 320 uses background radiation as a source of MID IR radiation. IR light emanates from a non-operating vehicle 323 and background and through the gas sample 324 surrounding the vehicle is gathered and focused by the telescope 326. The focused light passes through the spinning filter wheel 344 with discrete bandpass filters 352a-352d which are modeled around the gasoline vapor absorption spectrum centered around 3.4 microns and onto discrete detector 346.

Wheel 344 has two identical bandpass filters based on the gasoline vapor absorption spectrum and two reference filters. In the illustrated embodiment, two identical bandpass filters are used to both balance the wheel and increase the signal to noise ratio of the measurement. The reference filter's center wavelength and bandpass are based on the sides of the gasoline vapor absorption graph peak where the wavelengths are unaffected and, hence, make for acceptable reference point similar to the synthetic reference points discussed above. A control controls and monitors the speed, synchronization and detection of the filter wheel and detector components. The gathered information is then processed and used to identify the presence of gasoline vapor.

An evaporative vehicle emission loss detection system 420 is similar to system 320 and enhances the measurement signal by adding a MID IR source to the optical train. In this design, not only does the system use the emitted radiation of the vehicle and background, it uses the reflectance component of these objects. The figure below is a representation of this design. A MID IR source 422 is placed at the focal point of the telescope 426 in order to collimate IR radiation from the source that exits the front of the telescope. The user points the device at the vehicle of interest 423. IR light passes through the sample 424 surrounding the vehicle, strikes the vehicle and background and is reflected back based on its emissivity. The reflected light passes through sample 424 again, is collected and focused by the telescope 426 through the filter wheel 444 and into the MID IR detector 446. System 420 uses a beam splitter 430 that allows broad band IR to go through it, but reflects incoming IR through the filter wheel and into the detector 446 Like the other systems, the control portion 434 of the design is responsible for controlling and monitoring the speed, synchronization and detection of the filter wheel and detector components. The gathered information is then processed and used to identify the presence gasoline vapor.

An evaporative vehicle emission loss detection system 520 includes a detector 546 in the form of a Mid IR camera whose focal plane array (FPA) is placed at the image focal plane of telescope 526. Otherwise, system 520 is similar in construction to system 420.

An advantage is the ability of system 520 is to capture an image of a vehicle with the camera and, hence, identify areas of the vehicle that are emitting gasoline vapor. Each pixel of the FPA of the detector acts as a single detector and is processed identically to the other design for evaporative detection. As a matrix of pixels, the camera forms an image of the evaporative emission surrounding the vehicle. With the application of false color imaging, it is possible to display an image of the vehicle where regions of the vehicle would be displayed with specific colors that represent pass, fail and marginal levels of hydrocarbon where green is pass, red is failed, and the like. A false color image of a vehicle, but based on its temperature, is illustrated in FIG. 11.

The devices disclosed herein are used to remotely identify vehicles that emit evaporative emissions mainly hydrocarbons produced by distillate fuel vapors leaking from vehicles in situ, i.e., the vehicle parked and with the engine shut off. A method includes pointing the device at or immediately surrounding the vehicle of interest. A test is manually initiated and the device begins to take measurements of the air surrounding the vehicle. After a short test period, <1 second, the device indicates the results. The results could be as simple as a colored light indication, such as green for pass, yellow for marginal or red for fail. Or a more sophisticated determination could be applied, such as displaying specific levels of hydrocarbon with pass, fail, and marginal indicators. Or a real time display, such as shown in FIG. 14, which would indicate the level of evaporative emission using a dial with a color background indicating the level of emission.

The operator could walk around the vehicle selecting specific areas of the vehicle to test, such as the gas cap. Or the operator could be in a test vehicle with the device mounted on the exterior of the vehicle with the operator allowed to control the operational direction of the device. The operator drives around scanning vehicles for potential evaporative emission. Once a suspect vehicle is identified, further follow-up testing could be performed with the operator getting out of the vehicle and testing specific sections of the vehicle. A camera could be included with the system that would record an image of the vehicle with its license plate for additional testing.

When the test is made from a vehicle, care must be taken to avoid that vehicle's emission contaminating the devices test path. This is not only due to the possible presence of hydrocarbons, but also water vapor which can interfere with correct hydrocarbon measurements.

The devices and methods disclosed herein overcome the difficulty of current standardized evaporative tests that are either too onerous (IM240 purge and system pressure or FTP Diurnal test) or simplistic (gas cap integrity). The disclosed devices and methods provide an effective and quick technique for identification of vehicle evaporative emission status. They allow the user to point the device at a resting vehicle and identify whether that vehicle has evaporating emission and whether those evaporative emissions are sufficient enough to exceed acceptable limits and to warrant repair. Further, the technique can be used to locate potential areas of the vehicle that are at fault, such as the area around the gas cap. Alternatively, the device can be used to look under the hood or under the vehicle for the possible sources of the evaporative leak(s).

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

The embodiments of the invention in which an exclusive property or privilege is claimed are defined as follows:

1. An evaporative gas analysis system for detecting and measuring levels of hydrocarbons emitted from gasoline motor vehicles while stationary with the engine off, said system comprising:
a monochromatic source for producing and transmitting a beam of visible radiation through a portion of hydrocarbon gas surrounding the motor vehicle thereby causing the gas surrounding the vehicle to emit chromatic radiation based on the gas present;
a receiver position to receive the emitted chromatic radiation, said receiver including a plurality of chromatic sensors, each of said sensors generating an electrical signal indicative of transmission of hydrocarbon gas surrounding said vehicle; and
a control responsive to said chromatic sensors for computing the relative concentration of hydrocarbon gas surrounding the vehicle from the electrical signals.

2. The system according to claim 1 wherein the source is a visible laser beam.

3. The system according to claim 1 wherein the emitted chromatic radiation is generated by Raman spectral effect.

4. The system according to claim 1 wherein said monochromatic source uses light dispersion to generate different wavebands of light.

5. The system according to claim 1 wherein the plurality of sensors comprise a spectrometer.

6. The system according to claim 1 including a telescope head to focus the emitted chromatic radiation.

7. An evaporative gas analysis system for detecting and measuring levels of hydrocarbon gas emitted from gasoline motor vehicles while stationary with the engine off, said system comprising:
a source that produces and transmits a beam of infrared radiation through a portion of gas surrounding the vehicle, wherein the vehicle and a background of the vehicle reflects the infrared radiation through a portion of the gas surrounding said vehicle;
a receiver, said receiver positioned to receive the reflected infrared radiation;
an infrared sensor that is responsive to said receiver and generates an absorption electrical signal indicative of absorption of the hydrocarbon gas surrounding the vehicle and also generates an reference electrical signal indicative of the total radiation of the infrared beam by gas surrounding the vehicle;
a control responsive to the absorption and reference electrical signals from the infrared sensor for computing the relative concentration of the hydrocarbon gas through the portion of the gas surrounding the vehicle.

8. The system according to claim 7 wherein said infrared sensor generates a reference signal using time domain multiplexing.

9. The system according to claim 8, including a spinning filter wheel with one or more filters that identify absorption of hydrocarbon gas and one or more filters that identify reference radiation that is unaffected by the absorption of hydrocarbon gas to perform the time domain multiplexing.

10. The system according to claim 7 wherein said infrared sensor comprises a single infrared sensor.

11. The system according to claim 7 including a telescope head to focus the reflected infrared radiation.

12. An evaporative gas analysis system for detecting and measuring levels of hydrocarbons emitted from gasoline motor vehicles while stationary with the engine off, said system comprising:
a source of infrared radiation which passes through a portion of gas surrounding the vehicle;
a receiver that is positioned to receive the infrared radiation which passes through a portion of the gas surrounding the vehicle;
an infrared sensor that is responsive to said receiver to generate an electrical signal indicative of the absorption of the hydrocarbon gas surrounding the vehicle and to generate a reference electrical signal indicative of the total radiation of the source of infrared radiation; and
a control responsive to the electrical signals from the infrared sensor for computing the relative concentration of the hydrocarbon gas surrounding the vehicle that is emitted by the vehicle.

13. The system according to claim 12, wherein the source is the inherent infrared radiation of the vehicle and its background.

14. The system according to claim 12 wherein said infrared sensor includes a time division multiplexor to generate the electrical signal indicative of the absorption of the hydrocarbon gas and the reference electrical signal.

15. The system according to claim 14 wherein said time division multiplexor includes a spinning filter wheel with one or more filters that identifies the absorption of hydrocarbon gas and one or more filters that identifies the reference radiation that is unaffected by the absorption of hydrocarbon gas.

16. The system according to claim 12 including a telescope head to focus the received infrared radiation.

17. An evaporative gas analysis system for detecting and measuring levels of hydrocarbons emitted from gasoline motor vehicles while stationary with the engine off, said system comprising:
a source of infrared radiation which passes through a portion of the gas surrounding said vehicle;
a receiver that is positioned to receiving the infrared radiation reflected from gas surrounding the vehicle;
a plurality of infrared sensors that generate electrical signals indicative of the absorption of the hydrocarbon gas surrounding the vehicle and also generate a reference electrical signal indicative of the total radiation of said infrared beam by the gas surrounding the vehicle;
a control that is responsive to the electrical signals from said infrared sensors for computing the relative concentrations of hydrocarbon through the portion of the gas surrounding the vehicle.

18. The system according to claim 17 wherein the source is the inherent infrared radiation of the vehicle and its background.

19. The system according to claim 17 wherein the plurality of sensors comprise an MID IR camera.

20. The system as claimed in claim 17 wherein said plurality of sensors is provided by a time division multiplexor.

21. The system according to claim 20 wherein said time division multiplexor includes a spinning filter wheel with at least one filter that identifies the absorption of hydrocarbon gas and at least one other filter that identifies the reference radiation that is unaffected by the absorption of hydrocarbon gas.

22. The system according to claims 17 including a telescope head to focus the reflected infrared radiation.

23. The system according to claim 17 wherein said control uses a synthetic reference to calculate absolute absorption of evaporative emission.

24. The system according to claim 17 wherein said receiver comprises MID IR camera to identify the possible location of the evaporative leak.

25. The system according to claim 17 wherein said control determines whether the measured hydrocarbon emissions exceed an acceptable limit and warrant repair of the vehicle.

26. The system according to claim 25 wherein said control locates potential areas of the vehicle that are possible sources of hydrocarbon emission.

27. The system according to claim 26 directed under the hood of the vehicle to locate the possible sources of the hydrocarbon leak(s).
